(19) United States
(12) Patent Application Publication
(10) Pub. No.: US 2015/0067807 A1
(43) Pub. Date: Mar. 5, 2015

(54) OPERATING A USER DEVICE

(71) Applicant: Metaswitch Networks Ltd, Enfield (GB)

(72) Inventors: Matthew WILLIAMS, Enfield (GB); Keith WANSBROUGH, Enfield (GB); Andrew CALDWELL, Enfield (GB)

(21) Appl. No.: 14/468,903

(22) Filed: Aug. 26, 2014

(30) Foreign Application Priority Data
Aug. 31, 2013 (GB) 1315538.7

(51) Int. Cl. H04L 29/06; H04W 4/00; H04L 9/32; H04W 12/06

(52) U.S. Cl. CPC H04L 63/083; H04L 65/40; H04W 12/06; H04W 4/001; H04L 9/3226; H04W 80/10
USPC 726/7

(57) ABSTRACT

Measures for operating a user device in a telecommunications network. In a browser on the user device, a password associated with a given telephony service identifier is stored in a browser cache associated with the browser. A user of the user device has one or more telephony service identifiers, including the given telephony service identifier, allocated by a service provider for conducting communication services in the network. In the browser on the user device, in response to receipt of user input via the browser indicative of a request to conduct communications using the given telephony service identifier, the stored password is retrieved from the browser cache and used to authenticate the user device for at least one communication service in the network using the given telephony service identifier.

### CROSS-REFERENCE TO RELATED APPLICATIONS

This application claims priority under 35 U.S.C. §119(a) to UK Patent Application No. 1315538.7, filed on Aug. 31, 2013, the entire content of which is hereby incorporated by reference.

### BACKGROUND OF THE INVENTION

1. Field of the Invention

The present disclosure relates to operating a user device. In particular, but not exclusively, the present disclosure relates to operating a user device in a telecommunications network.

2. Description of the Related Technology

Session Initiation Protocol (SIP) is a protocol used in negotiating and controlling voice over internet protocol (VoIP) services, especially in modern IP Multimedia Subsystem (IMS) networks, which are starting to be deployed by service providers the world over. To use a SIP service, a user has to request a telephony service identifier such as a telephone dialing number (or ‘line’) from a service provider. This line identifies a user, allowing calls to reach the intended recipient, and also acts as a store for any user configuration associated with that user. To use a line, the user configures a device (for example a desk-phone, smart-phone, soft-phone, etc.) with the line in question and the device will then register with the service provider and can make and receive calls on the given line.

One user may have multiple lines allocated to them by their service provider (e.g. home line, mobile line, business line) since they may wish to have different configuration for each line, or may wish to use different over-the-top services on each.

In order to protect and limit service, each line is secured with a password that must be supplied by a device that wishes to register on that line. The password is used to confirm that the device is really owned by the human user of the system. Users will commonly use different credentials on each line to prevent one device accidentally registering on the wrong line (for example a son's tablet registering as a dad's business line, on the day of an important call from a customer).

From a user's perspective, once they have signed in to a communication service or user account associated with such (for example via a service provisioning client or suchlike) they have proven their identity and are in a position of absolute power over the configured lines on their account. For example the user can create, destroy, re-configure and change the password on their lines from the service provisioning client. Given this position, the user would not expect to have to re-prove their identity to actually use the lines from within the service provisioning client, in particular, they should not have to authenticate themselves in order to use one of their lines. Displaying a password page and requiring the user to type in (or copy-and-paste from a previous screen) the password from their account page in the service provisioning client would not provide a good user experience.

There are several existing services (for example 1Password™, LastPass™, KeePass™) that will hold long, complex passwords in secure databases on a user's local device protected by a master password where knowledge of only one credential is required to use multiple services. These services all work in a similar way, namely when a user tries to use an online service, they are presented with a login page/screen, requiring the user to open up the tool, give the master password and the domain/username which they wish to use and the tool will return the stored password for the user to paste into the login page. Some of these services have browser plugins that will detect and fill in login forms for a user, allowing the user to simply press the login button. These services require filling out of a login form/page.

Another similar tool is multiple identity support provided by Google™. This allows a user to be logged in on many identities simultaneously, each identity having separate passwords. Once the user has done this, the user can then chose to act under any of the user identities via a selection in a pull-down menu. The mechanism by which each identity signs on requires filling out a login form/page.

It would therefore be desirable to provide measures for improved operation of user devices, including streamlined log-in procedures for conducting communications.

### SUMMARY

According to embodiments of the present disclosure, there is a method of operating a user device in a telecommunications network, the method comprising: in a browser on the user device, storing, in a browser cache associated with the browser, a password associated with a given telephony service identifier, wherein a user of the user device has one or more telephony service identifiers, including the given telephony service identifier, allocated by a service provider for conducting communication services in the network; and in the browser on the user device, in response to receipt of user input via the browser indicative of a request to conduct communications using the given telephony service identifier, retrieving the stored password from the browser cache and using the retrieved password to authenticate the user device for at least one communication service in the network using the given telephony service identifier.

According to embodiments of the present disclosure, there is a system for use in operating a user device in a telecommunications network, the system comprising: at least one memory including computer program code; and at least one processor in data communication with the at least one memory, wherein the at least one processor is configured to: in a browser on the user device, store in a browser cache associated with the browser, a password associated with a given telephony service identifier, wherein a user of the user device has one or more telephony service identifiers, including the given telephony service identifier, allocated by a service provider for conducting communication services in the network; and in the browser on the user device, in response to receipt of user input via the browser indicative of a request to conduct communications using the given telephony service identifier, retrieve the stored password from the browser cache and using the retrieved password to authenticate the user device for at least one communication service in the network using the given telephony service identifier.

According to embodiments of the present disclosure, there is a non-transitory computer-readable storage medium comprising computer-executable instructions which, when executed by a processor, cause a computing device to perform a method of operating a user device in a telecommunications network, the method comprising: in a browser on the user device, storing, in a browser cache associated with the browser, a password associated with a given telephony service identifier, wherein a user of the user device has one or more telephony service identifiers, including the given telephony service identifier, allocated by a service provider for conducting communication services in the network; and in the browser on the user device, in response to receipt of user input via the browser indicative of a request to conduct communications using the given telephony service identifier, retrieving the stored password from the browser cache and using the retrieved password to authenticate the user device for at least one communication service in the network using the given telephony service identifier.

Further features of embodiments will become apparent from the following description of preferred embodiments of the present disclosure, given by way of example only, which is made with reference to the accompanying drawings.

### BRIEF DESCRIPTION OF THE DRAWINGS

FIG. 1 shows a system diagram according to one or more embodiments of the present invention.

### DETAILED DESCRIPTION OF CERTAIN INVENTIVE EMBODIMENTS

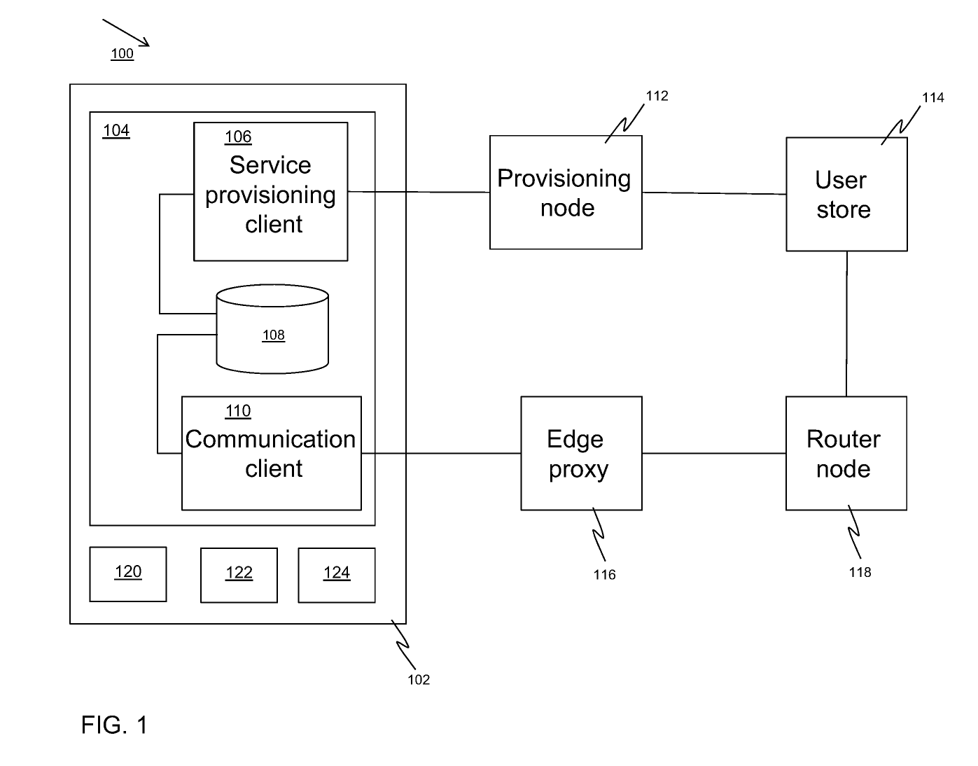

FIG. 1 shows a system diagram including a telecommunications network 100 in which embodiments of the present disclosure can be employed according to embodiments. Telecommunications network 100 includes a user device 102, a service provisioning node 112, a user store 114, an edge proxy 116 and a router node 118.

A user is associated with user device 102 (or ‘endpoint device’ or ‘user equipment’) through which they may conduct communication sessions (or ‘voice/video calls’ or ‘media sessions’) with user devices (not shown) of remote parties. User device 102 may for example comprise a desk phone, a mobile (or ‘cellular’) telephone, a tablet, a personal computer, etc. User device comprises a browser 104 which includes a service provisioning client 106, a communication client 110 and a browser cache 108. The user of user device 102 has one or more telephony service identifiers allocated by a service provider for conducting communication services in telecommunications network 100. The telephony service identifiers relate to different lines via which the user may conduct communications and may for example comprise telephone dialing numbers.

User device 102 comprises a processor 120 for carrying out data processing tasks of embodiments. User device 102 comprises a user interface 122 for collecting user input from a user of the device (for example via browser 104), for example user input associated with initiating and acceptance of communication sessions, such as telephone dialing number digits or incoming call acceptance or rejection commands. In embodiments, user device 102 comprises a display 124 for displaying appropriate information to the user.

User device 102 is able to communicate with telecommunications network 100 via edge proxy node 116. The communication link between user device 102 and edge proxy node 116 may further comprise one or more intermediate entities, such as wireless access points, routing devices, etc. Edge proxy node 116 may be further responsible for interfacing between telecommunications network 100 and one or more further user devices (not shown). Telecommunications network 100 may also comprise one or more further edge proxy nodes (not shown), each responsible for interfacing between telecommunications network 100 and a number of yet further user devices (not shown). For example, each further edge proxy node may provide access to telecommunications network 100 for user devices in different geographic locations.

Service provisioning node 112 is a network node operated by the service provider via which users may provision their communication services, for example request new lines, amend configuration for existing lines, amend user account details, etc. Service provisioning node 112 provides a web service where users can create an account and then, within their account, for example request multiple lines that they can then configure their SIP devices to register with.

User store 114 is a network node responsible for authenticating user devices in telecommunications network 100 and contains a data store for storing user configuration data. In the case of IMS, user store 114 may, for example, comprise a Home Subscriber Server (HSS).

Router node 118 is a network node responsible for processing routing data relating to communication sessions conducted in telecommunications network 100. In practice, telecommunications network may comprise many more such router nodes (not shown). Router node 118 may comprise a node performing the functions of one or more Call Session Control Functions (CSCFs), SIP Routers, SIP Registrars, SIP Service Nodes, SIP Proxies, etc.

Embodiments comprise measures, including methods, apparatus and computer software for operating a user device 102 in a telecommunications network 100. A user of user device 102 has one or more telephony service identifiers allocated by a service provider for conducting communication services in the network. In a browser 104 on user device 102, a password associated with a given telephony service identifier of the one or more telephony service identifiers is stored in browser cache 108 associated with browser 104. In response to receipt of user input via the browser indicative of a request to conduct communications using the given telephony service identifier, the stored password is retrieved from browser cache 108 and used to authenticate user device 102 for at least one communication service in the network using the given telephony service identifier.

At least one of the one or more telephony service identifiers may for example comprise a telephone dialing number.

In embodiments, browser cache 108 comprises a hypertext markup language (HTML) 5 browser cache. Browser cache 108 allows a webpage to store data on the client device to be retrieved at a later date. The browser cache in HTML5 is segregated by domain, so that a website on a different domain cannot therefore steal the credentials from the service provisioning client 106/communication client 110 domain.

In embodiments, the retrieving and authentication are carried out without requiring the user to enter further user input on user device 102.

In embodiments, the retrieving and authentication are carried out without requiring the user to enter the password as further user input on user device 102.

Embodiments comprise, prior to the storing, receiving via the network, from service provisioning node 112 associated with the service provider, the password associated with the given telephony service identifier; in such embodiments, the storing is carried out in response to receipt of the password via the network.

In some embodiments, the password is received in response to a request from user device 102 for allocation of a new telephony service identifier for the user. In other embodiments, the password is received in response to a request from user device 102 for allocation of a new password for a telephony service identifier previously allocated to the user.

In embodiments, the user has a user account with the service provider. In such embodiments, prior to the storing, a log-in process for the user is conducted between user device 102 and service provisioning node 112 associated with the service provider such that the user is logged-in to the user account when the password associated with the given telephony service identifier is stored in browser cache 108.

In embodiments, the log-in process is conducted via service provisioning client 106 embedded within browser 104 and the storing is performed by service provisioning client 106. In some such embodiments, service provisioning client 106 comprises a web portal.

In embodiments, one or more of the retrieving and the authentication are carried out by a communication client 110 embedded within browser 104. In some such embodiments, the user input is received via communication client 110 embedded within browser 104. Communication client 110 may for example comprise a SIP client such as a web Real Time Communication (webRTC) SIP client.

WebRTC is a service which provides the ability to make calls directly from a web-browser, for example using SIP as the signaling protocol and Session Description Protocol (SDP) for negotiation of media streams. WebRTC services are able to talk a form of SIP to the service provider, and may have an identical security model to standard SIP services.

Users can use communication client 110 as an in-browser communication client for any of their lines, talking to the rest of the SIP core in the network. Communication client 110 can for example be launched by clicking a button next to the line that the user wishes to use for conducting communications.

In embodiments, the authentication comprises connecting to the at least one communication service in the network using WebSocket™.

In embodiments, the at least one communication service comprises a VoIP and/or SIP communication service.

In embodiments, the storing comprises storing the password in browser cache 108 in an encrypted form, for example using a salted hash.

In embodiments, the user of user device 102 has a plurality of telephony service identifiers allocated by the service provider for conducting communication services in the network. In such embodiments, multiple passwords associated with multiple telephony service identifiers of the plurality of telephony service identifiers are stored in browser cache 108 associated with browser 104. In response to receipt of user input via browser 104 indicative of a request to conduct communications using a particular telephony service identifier of the plurality of telephony service identifiers, a particular stored password associated with the particular telephony service identifier is retrieved from browser cache 108 and used to authenticate user device 102 for a communication service in the network using the particular telephony service identifier.

Embodiments allow the user to authenticate their user device for communications in the network using a given telephony service identifier without having to enter in the password themselves. Embodiments provide an improved user experience as no log-in page needs to be completed when the user wishes to conduct communications using a given telephony service identifier. Embodiments do not require installation of a separate plugin/app and will work with any existing browser which has a browser cache. Embodiments only require a log-in page to be displayed in relation to accessing a line if the user has not entered the password before (unless provisioning node 112 has never sent the password to provisioning client 106 and the user has never entered the password in manually).

In embodiments, when a new line is created for a user, the line's credentials are stored on the user's device such that they can be retrieved and used to register the line for conducting communications.

An example description of provisioning of a new telephony service identifier for a user according to embodiments is now given. The user signs in to service provisioning client 106 and asks for a new telephony service identifier. Service provisioning client 106 sends a request for the new telephony service identifier to service provisioning node 112. Service provisioning node 112 determines an identifier and associated password for the user. The password is transmitted to user store 114 where it is stored in association with the user. Service provisioning node 112 also sends the new telephony service identifier and associated password to service provisioning client 106 of browser 104 of user device 102. The new telephony service identifier and password are displayed to the user (for example via display 124) and the password is stored in browser cache 108 for subsequent retrieval.

An example description of a user using communication client 110 to access communication services in the network according to embodiments is now given. The user signs in to service provisioning client 106 and requests communication client 110 to communicate using a given telephony service identifier. Browser 104 opens a new tab for communication client 110 telling communication client 110 which telephony service identifier was requested by the user. Communication client 110 looks in browser cache 108 for the previously stored password and retrieves the appropriate password. Communication client 110 then connects to the communication service (in this case via edge proxy 116), for example using WebSocket™ and uses the password retrieved from browser cache 108 to authenticate the user in the network for communication services using the given telephony service identifier. Edge proxy 116 routes the request to the SIP core (in this case SIP router node 118). SIP router node 118 looks up the credentials stored in user store 114 to validate the user's identity and allows them access to the communication service, in this case a SIP communication service.

In embodiments, when service provisioning node allocates a new line for a user, it transmits the password for the new line to service provisioning client 106. Service provisioning client 106 also receives a similar message when the user requests a new password for an existing line already allocated to the user. On receiving one of these messages, service provisioning client 106 displays the given password on user device 102. In embodiments, service provisioning client 106 creates a salted hash of the password (this hash is actually the first half of the hashing required to use the password for SIP authentication) and stores this in browser cache 108, paired with the line's identity. In this way, browser cache 108 will be populated with all the {identity, hash} pairs for the lines owned by the user.

In embodiments, when the user clicks an appropriate button to launch communication client 110 for a given line, a new window is created in the browser which loads communication client 110, which is told the identity of the line in question (as well as possibly some other, service-specific information such as the hostname to connect to). Communication client 110 then looks in browser cache 108 to find the relevant {identity, hash} pair and uses the hash to register the line for communication services in the network.

In embodiments, if the line identity cannot be found in the browser cache, then the password has not been seen previously by this browser instance and communication client 110 will prompt for the password to be supplied with a standard login screen and, once valid credentials (i.e. credentials that have been accepted for authentication) have been entered, will save them in the browser cache for later use.

In embodiments, if the credentials are retrieved from the cache, but fail the authentication to the communication service, they are removed from the cache and the user is prompted for the correct password. This may occur where, for example, the user changed the password for their line from a different browser instance (possibly on a separate user device).

Note that, since SIP authentication is two-phase and that the first part of this can be performed before the password is stored in the browser cache, this means that the underlying password is protected without needing to modify the SIP service to handle communication client 110 as a special case. In embodiments where a user chooses the password for one or more of their lines, there is a possibility that a user might use a password that they also use on another service, for example their bank account. In embodiments, since the password is not retrieved from the browser cache (such as a HTML 5 cache) in plaintext, the worst that can happen is that the user's SIP line may be compromised, but their bank account would not be.

In embodiments, the password could be further encrypted in service provisioning client 106 and/or communication client 110. This would mean that extracting the hash from the browser cache would be insufficient to steal SIP service from a user. Since the hash only allows access to that specific line and the rightful owner is still the only person with admin rights to the account, the damage can be mitigated by simply deleting the line, or changing the password.

Several users may wish to access communication services from a single user device, and it may be possible for one user to access communication services using another user's cached password. This could for example occur when a first user signs in to provisioning node 112 using a given user device, requests an identity A say such that their password is saved in the browser cache of the given user device, and then signs out. If a second user then signs in using the given user device and attempts to access communication services using identity A, then the browser will check the browser cache, find the password which the first user entered and use this to successfully register; the second user is thus able to steal the first user's service.

Therefore, embodiments comprise securing the browser cache on a user device to avoid one user being able to access communication services using another user's cached password. Embodiments ensure that the data stored in the cache is only readable by the user who stored it. In embodiments, the data is encrypted with a key that is only known/accessible by that user (and not other users). In embodiments, the storing comprises encrypting the password using a key that is unique to the user. The encryption may for example comprise use of a hash function.

The key may be generated/discovered in several different ways, for example as per the following three embodiments:

In a first embodiment, the provisioning server, which authenticates the provisioning user's identity, holds a secret key for each user and provides it to the user upon login (for example as the last 16 characters of the session ID, or a custom Hypertext Transfer Protocol (HTTP) header, or a hidden field in HTML generated for the page).

In a second embodiment, the key is calculated by the service provisioning client from the user's password (which may involve remembering the password beyond the initial sign-in).

In a third embodiment, a combination of the first and second embodiments is employed where the provisioning server calculates the key from the password upon sign-in and returns it to the user.

In embodiments, the key is the same every time the user tries to access the cache. In embodiments, the key is made unrecoverable when the user signs out of the provisioning client.

Embodiments comprise generating a random hash on provisioning node 112 when a first user first signs up (which is supplied back to provisioning client 106 whenever the first user signs in) and using the random hash to encrypt password hashes before inserting them into browser cache 108 and decrypting them when retrieving them in browser 104. Since a second user has no access to the first user's secret hash, the second user cannot decrypt the password hashes for the first user's lines and thus cannot steal the first user's service.

The above embodiments are to be understood as illustrative examples of the present disclosure. Further embodiments are envisaged.

In embodiments, communication client 110 is not a standard web application, but is actually a VoIP application embedded (or ‘wrapped up’) in the browser. This direction of hosting arbitrary services through a web portal is becoming more popular across the whole web and, as more encapsulated services are added, this problem of managing access to each service from a master account will keep recurring. Embodiments described herein can therefore be applied to any arbitrary authentication system used by a backend service.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the present disclosure, which is defined in the accompanying claims.

What is claimed is:

1. A method of operating a user device in a telecommunications network, the method comprising:
in a browser on the user device, storing, in a browser cache associated with the browser, a password associated with a given telephony service identifier, wherein a user of the user device has one or more telephony service identifiers, including the given telephony service identifier, allocated by a service provider for conducting communication services in the network; and
in the browser on the user device, in response to receipt of user input via the browser indicative of a request to conduct communications using the given telephony service identifier, retrieving the stored password from the browser cache and using the retrieved password to authenticate the user device for at least one communication service in the network using the given telephony service identifier.

2. The method of claim 1, comprising, prior to the storing, receiving via the network, from a service provisioning node associated with the service provider, the password associated with the given telephony service identifier,
wherein the storing is carried out in response to receipt of the password via the network.

3. The method of claim 2, wherein the password is received in response to a request from the user device for allocation of a new telephony service identifier for the user.

4. The method of claim 2, wherein the password is received in response to a request from the user device for allocation of a new password for a telephony service identifier previously allocated to the user.

5. The method of claim 1, wherein the user has a user account with the service provider, the method comprising:
prior to the storing, conducting a log-in process for the user between the user device and a service provisioning node associated with the service provider, whereby the user is logged-in to the user account when the password associated with the given telephony service identifier is stored in the browser cache.

6. The method of claim 5, wherein the log-in process is conducted via a service provisioning client embedded within the browser and the storing is performed by the service provisioning client.

7. The method of claim 6, wherein the service provisioning client comprises a web portal.

8. The method of claim 1, wherein the retrieving and authentication are carried out without requiring the user to enter further user input on the user device.

9. The method of claim 1, wherein the retrieving and authentication are carried out without requiring the user to enter the password as further user input on the user device.

10. The method of claim 1, wherein one or more of the retrieving and the authentication are carried out by a Session Initiation Protocol (SIP) client embedded within the browser.

11. The method of claim 10, wherein the user input is received via the SIP client embedded within the browser.

12. The method of claim 11, wherein the SIP client comprises a web Real Time Communication (webRTC) SIP client.

13. The method of claim 1, wherein the authentication comprises connecting to the at least one communication service in the network using websocket.

14. The method of claim 1, wherein the at least one communication service comprises a voice over internet protocol (VoIP) and/or SIP communication service.

15. The method of claim 1, wherein the storing comprises storing the password in the browser cache in an encrypted form.

16. The method of claim 15, wherein the storing comprises encrypting the password using a key that is unique to the user.

17. The method of claim 16, wherein the encrypting comprises use of a hash function.

18. The method of claim 1, wherein the browser cache comprises a hypertext markup language (HTML) 5 browser cache.

19. The method of claim 1, wherein the user of the user device has a plurality of telephony service identifiers allocated by the service provider for conducting communication services in the network, the method comprising:
storing, in the browser cache associated with the browser, multiple passwords associated with multiple telephony service identifiers of the plurality of telephony service identifiers; and
in response to receipt of user input via the browser indicative of a request to conduct communications using a particular telephony service identifier of the plurality of telephony service identifiers, retrieving a particular stored password from the browser cache associated with the particular telephony service identifier and using the particular retrieved password to authenticate the user device for a communication service in the network using the particular telephony service identifier.

20. The method of claim 1, wherein at least one of the one or more telephony service identifiers comprises a telephone dialing number.

21. A system for use in operating a user device in a telecommunications network, the system comprising:
at least one memory including computer program code; and
at least one processor in data communication with the at least one memory, wherein the at least one processor is configured to:
in a browser on the user device, store in a browser cache associated with the browser, a password associated with a given telephony service identifier, wherein a user of the user device has one or more telephony service identifiers, including the given telephony service identifier, allocated by a service provider for conducting communication services in the network; and
in the browser on the user device, in response to receipt of user input via the browser indicative of a request to conduct communications using the given telephony service identifier, retrieve the stored password from the browser cache and using the retrieved password to authenticate the user device for at least one communication service in the network using the given telephony service identifier.

22. A non-transitory computer-readable storage medium comprising computer-executable instructions which, when executed by a processor, cause a computing device to perform a method of operating a user device in a telecommunications network, the method comprising:
in a browser on the user device, storing, in a browser cache associated with the browser, a password associated with a given telephony service identifier, wherein a user of the user device has one or more telephony service identifiers, including the given telephony service identifier, allocated by a service provider for conducting communication services in the network; and
in the browser on the user device, in response to receipt of user input via the browser indicative of a request to conduct communications using the given telephony service identifier, retrieving the stored password from the browser cache and using the retrieved password to authenticate the user device for at least one communication service in the network using the given telephony service identifier.
